(19) United States
(12) Patent Application Publication
(10) Pub. No.: US 2024/0414033 A1
(43) Pub. Date: Dec. 12, 2024

(54) DATA COMMUNICATION APPARATUS WITH SELECTABLE SINGLE-ENDED OR DIFFERENTIAL SIGNAL TRANSMISSION

(71) Applicant: QUALCOMM Incorporated, San Diego, CA (US)

(72) Inventor: Faramarz SABOURI, San Diego, CA (US)

(21) Appl. No.: 18/333,384

(22) Filed: Jun. 12, 2023

(51) Int. Cl. H04L 25/06; H04L 25/03

(52) U.S. Cl. CPC H04L 25/061; H04L 25/03057

(57) ABSTRACT

An apparatus, includes: a data receiver circuit, comprising: a differential device configured to output a digital signal based on a differential data signal received via first and second transmission lines, or a single-ended data signal received via the first transmission line, wherein the differential device includes a first input configured to couple to the first transmission line; and at least one switching device including a first terminal coupled to a second input of the differential device, a second terminal configured to couple to the second transmission line, and a third terminal configured to receive a reference voltage. Another apparatus includes: a data transmitter circuit, comprising: a first buffer configured to generate a first differential data signal or a single-ended data signal based on an input data signal; and a second buffer configured to generate a second differential data signal based on the input data signal or a fixed voltage potential.

### FIELD

Aspects of the present disclosure relate generally to data communication links, and in particular, to a data communication apparatus with selectable single-ended or differential signal transmission.

### BACKGROUND

Data communication links, such as serializer/deserializer (SERDES) links, are used to communicate data signals between integrated circuits (ICs) and other components. Some of the data communication links communicate data via differential signaling as it may provide higher quality (e.g., higher signal to noise ratio (SNR)) data transmission with a possible power penalty. Other data communication links communicate data via single-ended signaling as it may save the number of metal traces (transmission lines) between ICs or other components.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to an apparatus. The apparatus includes: a data receiver circuit, comprising: a differential device configured to output a digital signal based on a differential data signal received via first and second transmission lines, or a single-ended data signal received via the first transmission line, wherein the differential device includes a first input configured to couple to the first transmission line; and at least one switching device including a first terminal coupled to a second input of the differential device, a second terminal configured to couple to the second transmission line, and a third terminal configured to receive a reference voltage.

Another aspect of the disclosure relates to an apparatus. The apparatus includes: a data transmitter circuit, comprising: a first buffer configured to generate a first differential data signal or a single-ended data signal based on an input data signal; and a second buffer configured to generate a second differential data signal based on the input data signal or a fixed voltage potential.

Another aspect of the disclosure relates to a method. The method includes generating a first current from a first port to a second port of a data transmitter circuit via a data receiver circuit based on a first logic value of an input differential data signal; generating a second current from the second port to the first port of the data transmitter circuit via the data receiver circuit based on a second logic value of the input differential data signal; generating a third current from the first port to the second port of the data transmitter circuit via the data receiver circuit based on a third logic value of an input single-ended data signal; and generating substantially no current from either the first or second port to either the second or first port of the data transmitter circuit based on a fourth logic value of the input single-ended data signal, respectively.

Another aspect of the disclosure relates to an apparatus. The apparatus includes means for generating a first current from a first port to a second port of a data transmitter circuit via a data receiver circuit based on a first logic value of an input differential data signal; means for generating a second current from the second port to the first port of the data transmitter circuit via the data receiver circuit based on a second logic value of the input differential data signal; means for generating a third current from the first port to the second port of the data transmitter circuit via the data receiver circuit based on a third logic value of an input single-ended data signal; and means for generating substantially no current from either the first or second port to either the second or first port of the data transmitter circuit based on a fourth logic value of the input single-ended data signal, respectively.

Another aspect of the disclosure relates to an electronic device. The electronic device includes: a first transmission line; a second transmission line; a modem or transceiver including a data transmitter circuit, comprising: a first buffer configured to generate a first differential data signal or a single-ended data signal based on an input data signal and a mode signal indicating differential or single-ended signaling, respectively, wherein an output of the first buffer is coupled to the first transmission line; and a second buffer configured to generate a second differential data signal based on the input data signal or a fixed voltage potential based on the mode signal, respectively, wherein an output of the second buffer is coupled to the second transmission line; and the transceiver or the modem including a data receiver circuit, comprising: at least one switching device including first, second, and third terminals, wherein the second terminal is coupled to the second transmission line, and the third terminal is configured to receive a reference voltage, and wherein the at least one switching device is responsive to the mode signal; and a differential device including a first input coupled to the first transmission line, a second input coupled to the first terminal of the at least one switching device, and an output configured to generate an output digital signal based on the first and second differential data signals or the single-ended data signal.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1A illustrates a block diagram of an example data communication apparatus.

FIG. 1B illustrates a block/schematic diagram of an example data communication apparatus associated with a differential signal data lane.

FIG. 2A illustrates a block diagram of another example data communication apparatus.

FIG. 2B illustrates a block/schematic diagram of an example data communication apparatus associated with a single-ended signal data lane.

FIG. 3A illustrates a block diagram of another example data communication apparatus in accordance with another aspect of the disclosure.

FIG. 3B illustrates a block/schematic diagram of an example data communication apparatus associated with a selectable single-ended or differential signal data lane.

FIG. 4 illustrates a block diagram of another example data communication apparatus in accordance with another aspect of the disclosure.

FIG. 5 illustrates a block/schematic diagram of another example data communication apparatus associated with a selectable single-ended or differential signal data lane in accordance with another aspect of the disclosure.

FIG. 6 illustrates a flow diagram of an example method of communicating data in accordance with another aspect of the disclosure.

FIG. 7 illustrates a block diagram of an example electronic device in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

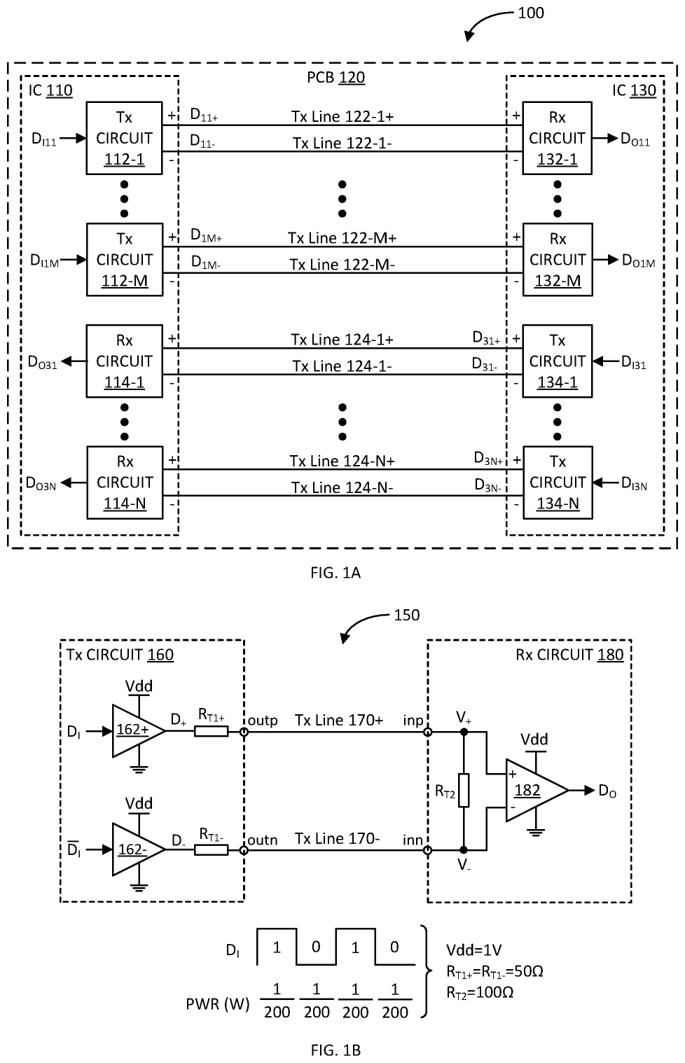

FIG. 1A illustrates a block diagram of an example data communication apparatus 100. As discussed in more detail herein, the data communication apparatus 100 communicates data via a serializer-deserializer (SERDES) communication link. That is, at a transmitting end, parallel data is converted into a set of serial data for transmission via a set of data transmission lines (also known as data lanes), respectively. At a receiving end, the set of serial data are received via the set of data transmission lines, respectively, and converted back to parallel.

In particular, the data communication apparatus 100 includes a first integrated circuit (IC) 110 and a second IC 130, both of which may be securely mounted on a printed circuit board (PCB) 120. As an example, with regard to an electronic device, such as a mobile device, smart phone, or other, the first IC 110 may include a modem and the second IC 130 may include a radio frequency (RF) transceiver.

The first IC 110 may include a set of one or more data transmitter (Tx) circuits 112-1 to 112-M, where M may be an integer of one or more. To implement bidirectional data communication, the first IC 110 may further include a set of one or more data receiver (Rx) circuits 114-1 to 114-N, where N may be an integer of one or more. Although the data communication apparatus 100 is described as being bidirectional, it shall be understood that the data communication apparatus 100 may be configured for unidirectional data communication. In such case, the first IC 110 may not include the set of one or more data receiver circuits 114-1 to 114-N. In an example mobile device use case, the integers M and N may each be equal to four (4), where four (4) data lanes are used to communicate uplink (UL) data from the modem IC 110 to the RF transceiver IC 130, and another four (4) data lanes are used to communicate downlink (DL) data from the RF transceiver IC 130 to the modem IC 110. However, it shall be understood that the integers M and N need not be four (4) and need not be the same.

The set of one or more data transmitter circuits 112-1 to 112-M are configured to receive a set of one or more input data signals D_{I11} to D_{I1M}, respectively. The set of one or more data transmitter circuits 112-1 to 112-M are configured to generate a set of one or more differential data signals D₁₁₊/D₁₁₋ to D_{1M+}/D_{1M-} based on the one or more input data signals D_{I11} to D_{I1M}, respectively. The set of one or more data transmitter circuits 112-1 to 112-M are coupled to a first set of one or more data transmission lines (e.g., metal traces) 122-1+/122-1− to 122-M+/122-M− on the PCB 120 for transmission of the one or more differential data signals D11+/D11− to D1M+/D1M− to the second IC 130, respectively.

The set of one or more data receiver circuits 114-1 to 114-N are coupled to a second set of one or more data transmission lines (e.g., metal traces) 124-1+/124-1− to 124-N+/124-N− on the PCB 120 to receive a set of one or more differential data signals D31+/D31− to D3N+/D3N− from the second IC 130, respectively. The set of one or more data receiver circuits 114-1 to 114-N are configured to generate a set of one or more output data signals D_{O31} to D_{O3N} based on the set of one or more differential data signals D₃₁₊/D₃₁₋ to D_{3N+}/D_{3N-}, respectively.

The second IC 130 may include a set of one or more data receiver (Rx) circuits 132-1 to 132-M. To implement bidirectional data communication, as discussed, the second IC 130 may further include a set of one or more data transmitter (Tx) circuits 134-1 to 134-N. Also, as discussed, although the data communication apparatus 100 is described as bidirectional, it shall be understood that the data communication apparatus 100 may be configured for unidirectional data communication. In such case, the second IC 130 may not include the set of one or more data transmitter circuits 134-1 to 134-N.

The set of one or more data receiver circuits 132-1 to 132-M are coupled to the first set of one or more data transmission lines 122-1+/122-1− to 122-M+/122-M− to receive the set of one or more differential data signals D₁₁₊/D₁₁₋ to D_{1M+}/D_{1M-} from the first IC 110, respectively. The set of one or more data receiver circuits 132-1 to 132-M are configured to generate a set of one or more output data signals D_{O11} to D_{O1M} based on the set of one or more differential data signals D₁₁₊/D₁₁₋ to D_{1M+}/D_{1M-}, respectively.

The set of one or more data transmitter circuits 134-1 to 134-N are configured to receive a set of one or more input data signals D_{I31} to D_{I3N}, respectively. The set of one or more data transmitter circuits 134-1 to 134-N are configured to generate the set of one or more differential data signals D₃₁₊/D₃₁₋ to D_{3M+}/D_{3M-} based on the set of one or more input data signals D_{I31} to D_{I3N}, respectively. The set of one or more data transmitter circuits 134-1 to 134-N are coupled to the second set of one or more data transmission lines 124-1+/124-1− to 124-N+/124-N− for transmission of the one or more differential data signals D₃₁₊/D₃₁₋ to D_{3N+}/D_{3N-} to the first IC 110, respectively.

The use of differential signaling in data communication apparatus 100 may improve the quality of the data transmission. For example, differential signaling may be less prone to noise as noise cancellation may be achieved at the receiving end. Further, as discussed in more detail herein, differential signaling may achieve higher signal swing at the receiving end to further improve the signal-to-noise ratio (SNR) associated with the differential signals at the receiving end. Because of the improved quality in data transmission, differential signaling may be used for higher data rates (e.g.,>10 giga bits per second (Gbps)), and/or when there are significant signal transmission loses between the first and second ICs 110 and 130 (e.g., in the case the length of the data transmission lines is relatively long (e.g.,>six (6) inches) or the quality of the PCB 120 is poor). However, the use of differential signaling may come with a power penalty.

FIG. 1B illustrates a block/schematic diagram of an example data communication apparatus 150 associated with a differential signal data lane. As mentioned, the data communication apparatus 150 may be associated with one of the data lines of the data communication apparatus 100 previously discussed. In particular, the data communication apparatus 150 includes a data transmitter circuit 160, a data receiver circuit 180, and differential transmission lines 170+ and 170− coupling the transmitter circuit 160 to the receiver circuit 180. The transmitter circuit 160 may be an example implementation of any of the transmitter circuits 112-1 to 112-M and 134-1 to 134-N of the data communication apparatus 100. Similarly, the receiver circuit 180 may be an example implementation of any of the receiver circuits 114-1 to 114-N and 132-1 to 132-M of the data communication apparatus 100.

More specifically, the data transmitter circuit 160 includes a first buffer 162+ (e.g., may also be referred to as a driver, a level-shifter, and/or one or more cascaded inverters), a first termination resistor R_{T1+}, a second buffer 162− (e.g., may also be referred to as a driver, a level-shifter, and/or one or more cascaded inverters), and a second termination resistor R_{T1-}. The first buffer 162+ may be coupled between and receive power from an upper voltage rail Vdd and a lower voltage rail (e.g., ground). The first buffer 162+ is configured to receive an input differential (e.g., non-complementary) data signal D_{I}, and generate a positive differential data signal D₊ based on the input differential data signal D_{I}. The positive differential data signal D₊ may swing between substantially Vdd (e.g., 1V) and ground (e.g., 0V). Similarly, the second first buffer 162− may also be coupled between and receive power from the upper voltage rail Vdd and the lower voltage rail. The second buffer 162− is configured to receive the input differential (e.g., complementary) data signal D̅_̅{̅I̅}̅, to generate a negative differential data signal D. based on the input differential data signal D̅_̅{̅I̅}̅. The negative differential data signal D. may swing between substantially Vdd (e.g., 1V) and ground (e.g., 0V).

The first termination resistor R_{T1+} is coupled between the output of the first buffer 162+ and a positive output port outp (e.g., integrated circuit (IC) pin), which is coupled to a first end of the transmission line 170+ of a printed circuit board (PCB). To reduce signal reflections with regard to the transmission of the differential data signal D₊/D₋, the first termination resistor R_{T1+} may have a resistance substantially the same as a characteristic impedance of the transmission line 170+ (e.g., 50Ω). Similarly, the second termination resistor R_{T1-} is coupled between the output of the second buffer 162− and a negative output port outn (e.g., IC pin), which is coupled to a first end of the transmission line 170− of the PCB. Similarly, to reduce signal reflections with regard to the transmission of the differential data signal D+/D−, the second termination resistor R_{T1-} may have a resistance substantially the same as a characteristic impedance of the transmission line 170− (e.g., 50Ω). It shall be understood that the transmitter circuit 160 may include additional components, such as a serializer, one or more pre-driver stages, and other.

The data receiver circuit 180 includes a differential device 182 (e.g., a comparator or differential amplifier) including a first (e.g., positive) input coupled to a positive input port inp (e.g., IC pin), which is coupled to a second end of the transmission line 170+, and a second (e.g., negative) input coupled to a negative input port inn (e.g., IC pin), which is coupled to a second end of the transmission line 170−. The receiver circuit 180 includes a termination resistor R_{T2} coupled between the respective second ends of the differential transmission lines 170+ and 170−. As the termination resistor R_{T2} is coupled to two differential transmission lines 170+ and 170−, to reduce signal reflections with regard to the transmission of the differential data signal D₊/D₋, the termination resistor R_{T2} may have a resistance substantially twice the characteristic impedance of each of the transmission lines 170+ and 170− (e.g., 100Ω). The differential device 182 is configured to generate an output data signal D_{O} based on the differential data signal D₊/D₋ received from the transmitter circuit 160 via the differential transmission lines 170+ and 170−, respectively. It shall be understood that the receiver circuit 180 may include additional components, such as an amplifier, equalizer, clock and data recovery (CDR), deserializer, and other.

FIG. 1B also includes a graph including a signal waveform of the input data signal D_{I} and a corresponding power consumption (e.g., in watts (W)) associated with the transmission of the differential data signal D₊/D₋. For ease of explanation, it is assumed that the supply voltage at the upper voltage rail Vdd (referred to also as Vdd) is one (1) Volt (1V), and the voltage or potential at the lower voltage rail is ground or zero (0) Volt (0V). Further, as mentioned, it is assumed that the resistance of each of the termination resistors R_{T1+} and R_{T1-} of the transmitter circuit 160 is 50Ω, and the resistance of the termination resistor of the receiver circuit 180 is 100Ω. All other parameters are assumed to be ideal, such as the differential data signal D₊/D₋ swinging between 1V and 0V, and the characteristic impedance of the transmission lines 170+ and 170− is 100 Ω differential (or 50Ω single ended).

As the graph illustrates, when the input data signal D_{I} is a logic one (1), the differential data signal D₊ is at 1V and the differential data signal D₋ is at 0V. In such case, a current is formed that flows from the output of the first buffer 162+ to the output of the second buffer 162− via the first termination resistor R_{T1+}, the positive transmission line 170+, the receiver termination resistor R_{T2}, the negative transmission line 170−, and the second termination resistor R_{T1-}. The power consumed in transmitting the data is Vdd² divided by the total resistance R_{T1+}+R_{T2}+R_{T1-} (e.g., PWR=1V²/(200Ω)= 1/200 W), as illustrated. Similarly, when the input data signal D_{I} is a logic zero (0), the differential data signal D₊ is at 0V and the differential data signal D₋ is at 1V. In such case, a current is formed that flows from the output of the second buffer 162− to the output of the first buffer 162+ via the second termination resistor R_{T1-}, the negative transmission line 170−, the receiver termination resistor R_{T2}, the positive transmission line 170+, and the first termination resistor R_{T1+}. The power consumed in transmitting the data is Vdd² divided by the total resistance R_{T1+}+R_{T2}+R_{T1-} (e.g., PWR=1V²/(200Ω)= 1/200 W), as illustrated.

Besides power consumption, another parameter of interest is the voltage swing at the inputs of the differential device 182 of the receiver circuit 180. For example, when the input data signal D_{I} is a logic one (1), the voltage V₊ at the positive input of the differential device 182 is Vdd*(R_{T2}+R_{TI-})/(R_{T1+}+R_{T2}+R_{TI-}) (e.g., 1V*150Ω/200Ω=0.75V), and the voltage V− at the negative input of the differential device 182 is Vdd*R_{T1-}/(R_{T1+}+R_{T2}+R_{TI-}) (e.g., 1V*50 Ω/200Ω=0.25V). Similarly, when the input data signal D_{I} is a logic zero (0), the voltage V+ at the positive input of the differential device 182 is Vdd*R_{T1+}/(R_{T1+}+R_{T2}+R_{T1-}) (e.g., 1V*50Ω/200Ω=0.25V), and the voltage V− at the negative input of the differential device 182 is Vdd*(R_{T2}+RT₁₊)/(RT₁₊+R_{T2}+R_{T1-}) (e.g., 1V*150Ω/200Ω=0.75V). Thus, the peak-to-peak voltage difference between a logic one (1) and a logic zero (0) at the inputs of the differential device 182 is (0.75V−0.25V)−(0.25V−0.75V)=0.5V−(−0.5V)=1V.

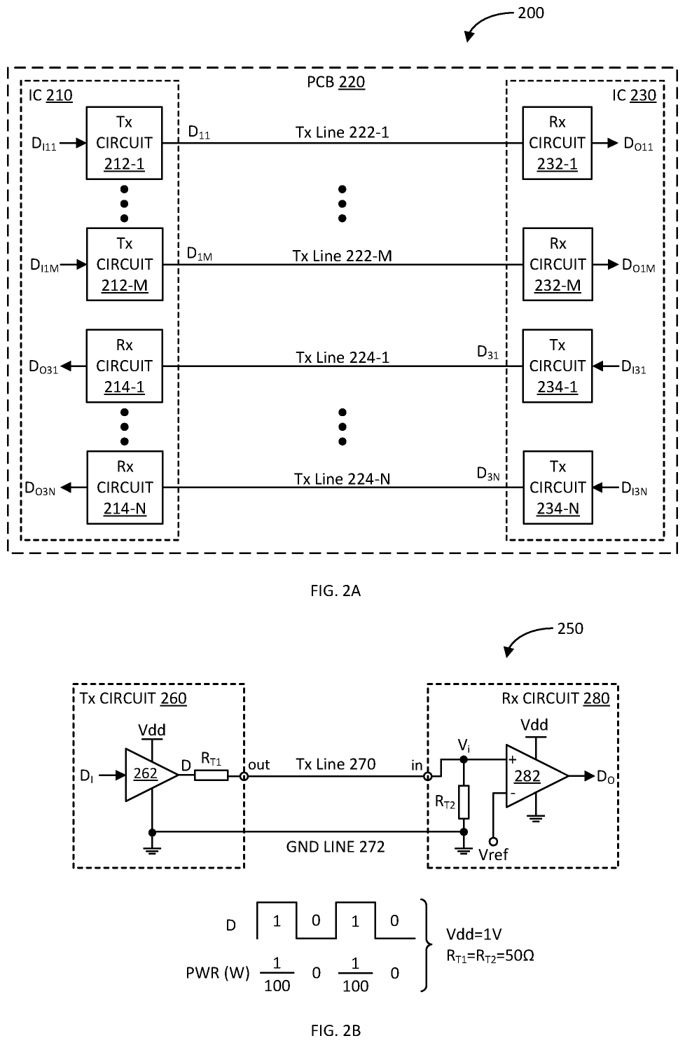

FIG. 2A illustrates a block diagram of another example data communication apparatus 200. The data communication apparatus 200 uses single-ended data signal transmission instead of differential data signal transmission as in data communication apparatus 100. Single-ended data transmission may be useful when the length of the data transmission is relatively short (e.g., one (1) inch as compared to six (6) inches), and/or when the quality of the PCB is comparatively good.

In particular, the data communication apparatus 200 includes a first integrated circuit (IC) 210 and a second IC 230, both of which may be securely mounted on a printed circuit board (PCB) 220. The first IC 210 may include a set of one or more data transmitter (Tx) circuits 212-1 to 212-M. To implement bidirectional data communication, the first IC 210 may further include a set of one or more data receiver (Rx) circuits 214-1 to 214-N. Although the data communication apparatus 200 is described as being bidirectional, it shall be understood that the data communication apparatus 200 may be configured for unidirectional data communication. In such case, the first IC 210 may not include the set of one or more data receiver circuits 214-1 to 214-N.

The set of one or more data transmitter circuits 212-1 to 212-M are configured to receive a set of one or more input data signals D_{I11} to D_{I1M}, and generate a set of one or more single-ended data signals D₁₁ to D_{1M} based on the set of one or more input data signals D_{I11} to D_{I1M}, respectively. The set of one or more data transmitter circuits 212-1 to 212-M are coupled to first a set of one or more data transmission lines (e.g., metal traces) 222-1 to 222-M on the PCB 220 for transmission of the set of one or more single-ended data signals D₁₁ to D_{1M} to the second IC 230, respectively. The set of one or more data receiver circuits 214-1 to 214-N are coupled to a second set of one or more data transmission lines (e.g., metal traces) 224-1 to 224-N on the PCB 120 to receive a set of one or more single-ended data signals D₃₁ to D_{3N} from the second IC 230, respectively. The set of one or more data receiver circuits 214-1 to 214-N are configured to generate a set of one or more output data signals D_{O31} to D_{O3N} based on the set of one or more single-ended data signals D₃₁ to D_{3N}, respectively.

The second IC 230 may include a set of one or more data receiver (Rx) circuits 232-1 to 232-M. To implement bidirectional data communication, as discussed, the second IC 230 may further include a set of one or more data transmitter (Tx) circuits 234-1 to 234-N. Also, as discussed, although the data communication apparatus 200 is described as being bidirectional, it shall be understood that the data communication apparatus 200 may be configured for unidirectional data communication. In such case, the second IC 230 may not include the set of one or more data transmitter circuits 234-1 to 234-N.

The set of one or more data receiver circuits 232-1 to 232-M are coupled to the first set of one or more data transmission lines 222-1 to 222-M to receive the set of one or more single-ended data signals D₁₁ to D_{1M} from the first IC 210, respectively. The set of one or more data receiver circuits 232-1 to 232-M are configured to generate a set of one or more output data signals D_{O11} to D_{O1M} based on the set of one or more single-ended data signals D₁₁ to D_{1M}, respectively. The set of one or more data transmitter circuits 234-1 to 234-N are configured to receive a set of one or more input data signals D_{I31} to D_{I3N}, and generate the set of one or more single-ended data signals D₃₁ to D_{3N} based on the set of one or more input data signals D_{I31} to D_{I3N}, respectively. The set of one or more data transmitter circuits 234-1 to 234-N are coupled to the second set of one or more transmission lines 224-1 to 224-N for transmitting the set of one or more single-ended data signals D₃₁ to D_{3N} to the first IC 210, respectively.

FIG. 2B illustrates a block/schematic diagram of an example data communication apparatus 250 associated with a single-ended signal data lane. As mentioned, the data communication apparatus 250 may be associated with one of the data lines of the data communication apparatus 200 previously discussed. In particular, the data communication apparatus 250 includes a data transmitter circuit 260, a data receiver circuit 280, a signal transmission line 270 coupling the transmitter circuit 260 to the receiver circuit 280, and a ground conductor line 272 common to both the transmitter and receiver circuits 260 and 280. The transmitter circuit 260 may be an example implementation of any of the transmitter circuits 212-1 to 212-M and 234-1 to 234-N of the data communication apparatus 200. Similarly, the receiver circuit 280 may be an example implementation of any of the receiver circuits 214-1 to 214-N and 232-1 to 232-M of the data communication apparatus 200.

More specifically, the data transmitter circuit 260 includes a buffer 262 (e.g., may also be referred to as a driver, level-shifter, and/or one or more cascaded inverters) and a termination resistor R_{T1}. The buffer 262 may be coupled between and receive power from an upper voltage rail Vdd and a lower voltage rail (e.g., ground). The buffer 262 is configured to receive an input data signal D_{I}, and generate a single-ended data signal D based on the input data signal D_{I}. The termination resistor R_{T1} is coupled between the output of the buffer 262 and an output port “out” (e.g., IC pin), which is coupled to a first end of the transmission line 270 of a printed circuit board (PCB). To reduce signal reflections with regard to the transmission of the single-ended data signal D, the termination resistor R_{T1} may have a resistance substantially the same as a characteristic impedance of the transmission line 270 (e.g., 50Ω). It shall be understood that the transmitter circuit 260 may include additional components, such as a serializer, one or more pre-driver stages, and other.

The data receiver circuit 280 includes a differential device 282 (e.g., a comparator or differential amplifier) including a first (e.g., positive) input coupled to an input port “in” (e.g., IC pin), which is coupled to a second end of the transmission line 270, and a second (e.g., negative) input configured to receive a reference voltage Vref, which may be set to Vdd/2. The receiver circuit 280 includes a termination resistor R_{T2} coupled between the respective second ends of the transmission line 270 and ground conductor line 272. Also, to reduce signal reflections with regard to the transmission of the single-ended data signal D, the termination resistor R_{T2} may have a resistance substantially the same as the characteristic impedance of the transmission line 270 (e.g., 50Ω). The differential device 282 is configured to generate an output data signal D_{O} based on the single-ended data signal D received from the transmitter circuit 260 via the transmission line 270. It shall be understood that the receiver circuit 280 may include additional components, such as an amplifier, equalizer, clock and data recovery (CDR), deserializer, and other.

FIG. 2B also includes a graph including a signal waveform of the single-ended data signal D and a corresponding power consumption (e.g., in watts (W)) associated with the transmission of the single-ended data signal D. Per the previous example, it is assumed that the supply voltage Vdd at the upper voltage rail Vdd is 1V, and ground potential is at 0V. Further, as mentioned, it is assumed that the resistance of each of the termination resistors R_{T1} and R_{T2} is 50Ω. All other parameters are assumed to be ideal, such as the single-ended data signal D swinging between 1V and 0V, and the characteristic impedance of the transmission line 270 is 50Ω.

As the graph illustrates, when the single-ended data signal D is a logic one (1), the data signal D is at 1V. In such case, a current is formed that flows from the output of the buffer 262 to ground via the termination resistors R_{T1} and R_{T2}. The power consumed in transmitting the data is Vdd² divided by the total resistance R_{T1}+R_{T2} (e.g., PWR=1V²/(100Ω)= 1/100 W), as illustrated. Similarly, when the single-ended data signal D is a logic zero (0), the data signal D is at 0V. In such case, no current is produced; and thus, the power consumed in transmitting the data is 0 W, as illustrated. Thus, the total power consumption for an interval including a logic one (1) followed by a logic zero (0) (e.g., a 1-0 interval) is 1/100 W. Thus, the total power consumption for the 1-0 interval is the same for the differential and single-ended data communication apparatuses 100 and 200.

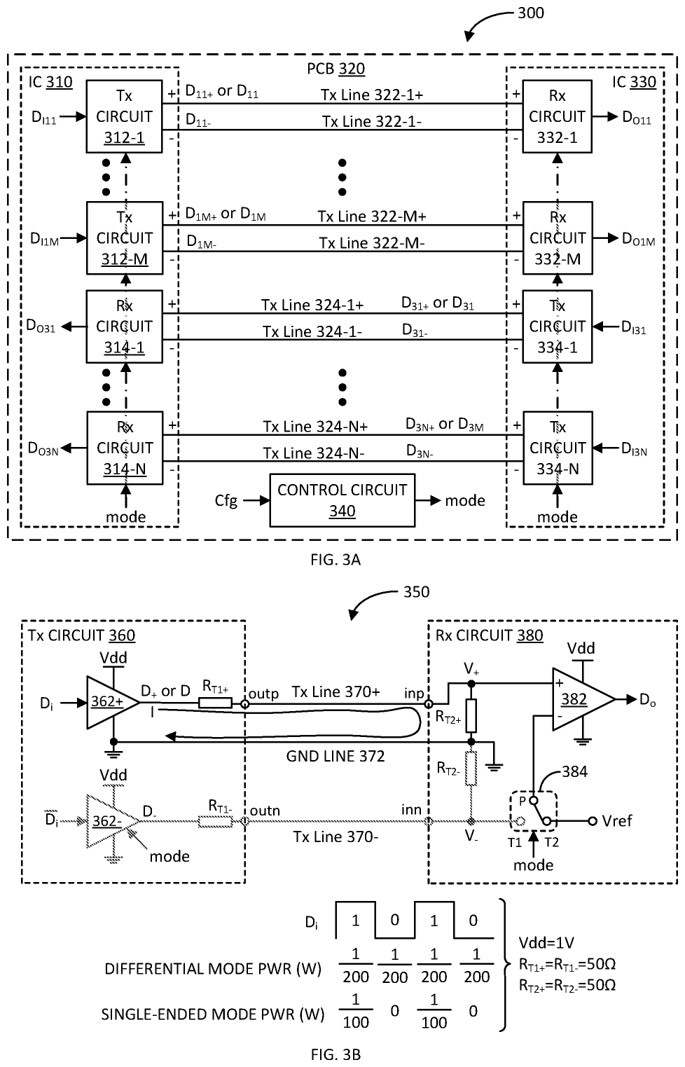

FIG. 3A illustrates a block diagram of another example data communication apparatus 300 in accordance with another aspect of the disclosure. There may be a need for both single-ended and differential data communication links in a single SERDES.

Accordingly, the data communication apparatus 300 may provide the desirable attributes of both communication links, by featuring a selectable single-ended or differential data communication link. For example, if the data transmission has a relatively low data rate specification (e.g., below a threshold data rate, such as 10 Gbps), the data communication apparatus 300 may be configured and operated in accordance with a single-ended signaling mode. If, on the other hand, the data transmission has a relatively high data rate specification (e.g., above the threshold data rate, such as 10 Gbps), the data communication apparatus 300 may be configured and operated in accordance with a differential signaling mode.

In particular, the data communication apparatus 300 includes a first integrated circuit (IC) 310 and a second IC 330, both of which may be securely mounted on a printed circuit board (PCB) 320. The first IC 310 may include a set of one or more data transmitter (Tx) circuits 312-1 to 312-M. To implement bidirectional data communication, the first IC 310 may further include a set of one or more data receiver (Rx) circuits 314-1 to 314-N. Although the data communication apparatus 300 is described as being bidirectional, it shall be understood that the data communication apparatus 300 may be configured for unidirectional data communication. In such case, the first IC 310 may not include the set of one or more data receiver circuits 314-1 to 314-N.

The set of one or more data transmitter circuits 312-1 to 312-M are configured to receive a set of one or more input data signals Din to DIM, respectively. Additionally, the set of one or more data transmitter circuits 312-1 to 312-M are configured to receive a mode signal indicating whether the data transmission is differential or single-ended. The set of one or more data transmitter circuits 312-1 to 312-M are coupled to a first set of one or more data transmission lines (e.g., metal traces) 322-1+/322-1− to 322-M+/322-M− on the PCB 320.

In differential signaling mode, the set of one or more data transmitter circuits 312-1 to 312-M are configured to generate a set of one or more differential data signals D₁₁₊/D₁₁₋ to D_{1M+}/D_{1M-} based on the one or more input data signals D_{I11} to D_{I1M} for transmission to the second IC 330 via the first set of one or more transmission lines 322-1+/322-1− to 322-M+/322-M−, respectively. In single-ended signaling mode, the set of one or more data transmitter circuits 312-1 to 312-M are configured to generate a set of one or more single-ended data signals D₁₁ to D_{1M} based on the one or more input data signals D_{I11} to D_{I1M} for transmission to the second IC 330 via the positive subset of one or more transmission lines 322-1+ to 322-M+, respectively. In single-ended signaling mode, the negative set of one or more transmission lines 322-1− to 322-M− may be disabled (e.g., tristated) in one implementation or serves as a single-ended current line in other implementations, as discussed further herein.

The set of one or more data receiver circuits 314-1 to 314-N are coupled to a second set of one or more data transmission lines (e.g., metal traces) 324-1+/324-1− to 324-N+/324-N− on the PCB 320. In differential signaling mode, the set of one or more data receiver circuits 314-1 to 314-N are configured to receive a set of one or more differential data signals D₃₁₊/D₃₁₋ to D_{3N+}/D_{3N-} from the second IC 330 via a second set of one or more data transmission lines 324-1+/324-1− to 324-N+/324-N−, respectively. In single-ended signaling mode, the set of one or more data receiver circuits 314-1 to 314-N are configured to receive a set of one or more single-ended data signals D₃₁ to D_{3N} from the second IC 330 via the positive subset of one or more data transmission lines 324-1+ to 324-N+, respectively. In single-ended signaling mode, the negative subset of one or more transmission lines 324-1− to 324-N− may be disabled (e.g., tristated) in one implementation or serves as a single-ended current line in other implementations, as discussed further herein. In both modes, the set of one or more data receiver circuits 314-1 to 314-N are configured to generate a set of one or more output data signals D_{O31} to D_{O3N} based on the received differential or single-ended signals, respectively.

The second IC 330 may include a set of one or more data receiver (Rx) circuits 332-1 to 332-M. To implement bidirectional data communication, as discussed, the second IC 330 may further include a set of one or more data transmitter (Tx) circuits 334-1 to 334-N. Also, as discussed, although the data communication apparatus 300 is described as being bidirectional, it shall be understood that the data communication apparatus 300 may be configured for unidirectional data communication. In such case, the second IC 330 may not include the set of one or more data transmitter circuits 334-1 to 334-N. The set of one or more data receiver circuits 332-1 to 332-M and the set of one or more data transmitter circuits 334-1 to 334-N may each be configured to receive the mode signal indicating whether the signaling is differential or single-ended.

The set of one or more data receiver circuits 332-1 to 332-M are coupled to the first set of one or more data transmission lines 322-1+/322-1− to 322-M+/322-M−, respectively. In differential signaling mode, the set of one or more data receiver circuits 332-1 to 332-M are configured to receive the set of one or more differential data signals D₁₁₊/D₁₁₋ to D_{1M+}/D_{1M-} from the first IC 310 via the first set of one or more data transmission lines 322-1+/322-1− to 322-M+/322-M−, respectively. In single-ended signaling mode, the set of one or more data receiver circuits 332-1 to 332-M are configured to receive the set of one or more single-ended data signals D₃₁ to D_{3M} from the first IC 310 via the positive subset of one or more data transmission lines 322-1+ to 322-M+, respectively. As discussed, in single-ended signaling mode, the negative subset of one or more transmission lines 322-1− to 322-M− may be disabled (e.g., tristated) in one implementation or serves as a single-ended current line in other implementations, as discussed further herein. In both modes, the set of one or more data receiver circuits 332-1 to 332-M are configured to generate a set of one or more output data signals Don to D_{O1M} based on the received differential or single-ended signals, respectively.

The set of one or more data transmitter circuits 334-1 to 334-N are configured to receive a set of one or more input data signals D_{I31} to D_{I3N}, respectively. The set of one or more data transmitter circuits 334-1 to 334-N are coupled to the second set of one or more data transmission lines 324-1+/324-1− to 324-N+/324-N− on the PCB 320, respectively. In differential signaling mode, the set of one or more data transmitter circuits 334-1 to 334-N are configured to generate the set of one or more differential data signals D₃₁₊/D₃₁₋ to D_{3N+}/D_{3N-} based on the one or more input data signals D_{I31} to D_{I3M} for transmission to the first IC 310 via the second set of one or more transmission lines 324-1+/324-1− to 324-N+/324-N−, respectively. In single-ended signaling mode, the set of one or more data transmitter circuits 334-1 to 334-N are configured to generate the set of one or more single-ended data signals D₁₁ to D_{1M} based on the one or more input data signals D_{I31} to D_{I3M} for transmission to the first IC 310 via the positive subset of one or more transmission lines 324-1+ to 324-N+, respectively. As discussed, in single-ended signaling mode, the negative subset of one or more transmission lines 324-1− to 324-N− may be disabled (e.g., tristated) in one implementation or serves as a single-ended current line in other implementations, as discussed further herein.

The data communication apparatus 300 may include a control circuit 340 configured to generate the single-ended/differential signaling mode based on a configuration signal. The configuration signal may specify the data rate for the data communication, may also specify firmware information as to the length of the transmission lines 322/324, may also specify firmware information as to the quality of the PCB 320, and/or other information that may be relevant to setting the mode to differential or single-ended. As an example, if the configuration signal indicates a data rate of less than a threshold (e.g., 10 Gbps), the control circuit 340 may set the mode signal to single-ended signaling. In such case, the transmitter and receiver circuits 312/334 and 314/332 may be configured to implement single-ended data signal transmission. Conversely, if the configuration signal indicates a data rate of more than a threshold (e.g., 10 Gbps), the control circuit 340 may set the mode signal to differential signaling. In such case, the transmitter and receiver circuits 312/334 and 314/332 may be configured to implement differential data signal transmission.

FIG. 3B illustrates a block/schematic diagram of an example data communication apparatus 350 associated with a selectable single-ended or differential signal data lane in accordance with another aspect of the disclosure. The data communication apparatus 350 may be an example of any of the data lanes (transmitter-transmission line-receiver) in data communication apparatus 300. In particular, the data communication apparatus 350 includes a data transmitter circuit 360, a data receiver circuit 380, and a set of transmission lines 370+ and 370−, and a ground conductor line 372, which may be disposed on a printed circuit board (PCB).

The transmitter circuit 360 includes a first buffer 362+ and a second buffer 362− (e.g., each of which may be referred to as a driver, level-shifter, and/or one or more cascaded inverters). Each of the first and second buffers 362+ and 362− may be coupled between and receive power from an upper voltage rail Vdd and a lower voltage rail (e.g., ground). The lower voltage rail or ground may be coupled to a first end of the ground conductor line 372 extending between the transmitter circuit 360 and the receiver circuit 380. The first buffer 362+ may be configured to generate a differential signal D+ or a single-ended signal D based on an input data signal Dᵢ. The transmitter circuit 360 further includes a first termination resistor R_{T1+} coupled between the output of the first buffer 362+ and a positive output port outp (e.g., IC pin), which is coupled to a first end of the transmission line 370+. To reduce reflections in the transmission of data signals, the resistance of the first termination resistor R_{T1+} may be set to substantially the characteristic impedance of the transmission line 370+ (e.g., 50Ω).

The second buffer 362− may include an input configured to receive a mode signal indicating whether the data transmission is single-ended or differential. Accordingly, if the mode signal indicates differential signaling, the second buffer 362− is configured to generate the differential signal D-based on the input (e.g., complementary) data signal D̅₁̅; and if the mode signal indicates single-ended signaling, the second buffer 362− may be disabled (e.g., tristated) ( ) to effectively remove the transmission line 370− and termination resistors R_{T1-} and R_{T2-} from the circuit, as indicated by the gray shading. The transmitter circuit 360 further includes the second termination resistor R_{T1-} coupled between the output of the second buffer 362− and a negative output port outn (e.g., IC pin), which is coupled to a first end of the transmission line 370−. To reduce reflections in the transmission of data signals, the resistance of the second termination resistor R_{T1-} may be set to substantially the characteristic impedance of the transmission line 370− (e.g., 50Ω).

The data receiver circuit 380 includes a differential device 382 (e.g., a comparator or differential amplifier), a first termination resistor R_{T2+}, a second termination resistor R_{T2-}, and at least one switching device 384. The differential device 382 is coupled between and receives power from the upper voltage rail Vdd and the lower voltage rail (e.g., ground). The differential device 382 includes a first (e.g., positive) input coupled to a positive input port inp (e.g., IC pin), which is coupled to a second end of the transmission line 370+, a second (e.g., negative) input coupled to a terminal (P) (e.g., pole) of the at least one switching device 384, which may be implemented or functions as a single pole double throw (SPDT) switch. The at least one switching device 384 includes another terminal or throw (T1) coupled to a negative input port inn (e.g., IC pin), which is coupled to a second end of the transmission line 370−. Further, the at least one switching device 384 includes yet another terminal or throw (T2) configured to receive a reference voltage Vref (e.g., set to the common mode voltage of the single-ended voltage swing at the inputs of the differential device 382, such as Vdd/4 or 0.25V if Vdd=1V). The at least one switching device 384 includes an input configured to receive the single-ended/differential mode signal, which controls the state of the at least one switching device 384 (e.g., when the mode signal indicates differential, the pole (P) is coupled to the first throw (T1); and when the mode signal indicates single-ended, the pole (P) is coupled to the second throw (T2)).

The first and second termination resistor R_{T2+} and R_{T2-} of the receiver circuit 380 are coupled in series between the second end of the transmission line 370+ and the second end of the transmission line 370−. The node between the first and second termination resistor R_{T2+} and R_{T2-} may be coupled to a grounded center tap, which may, in turn, be coupled to a second end of the ground conductor line 372.

FIG. 3B also includes a graph including a signal waveform of the input data signal Dᵢ and a corresponding power consumption (e.g., in watts (W)) associated with differential and single-ended data transmissions. In differential signaling mode, the data communication apparatus 350 operates similar to the standalone differential data communication apparatus 150 previously discussed.

For example, considering again Vdd=1V and R_{T1+}=R_{T1-}=R_{T2+}=R_{T2-}=50Ω, when the input data signal Dᵢ is a logic one (1), the differential data signal D₊ is at 1V and the differential data signal D₋ is at 0V. In such case, a current is formed that flows from the output of the first buffer 362+ to the output of the second buffer 362− via the first transmitter termination resistor R_{T1+}, the positive transmission line 370+, the first receiver termination resistor R_{T2+}, the second receiver termination resistor R_{T2-}, the negative transmission line 370−, and the second transmitter termination resistor R_{T1-}. As the differential voltage V₊−V₋ at the inputs of the differential device 382 is positive, the differential device 382 generates an output data signal D_{O} as a logic one (1). The power consumed in transmitting the data is 1V²/200Ω= 1/200W. Similarly, when the input data signal Dᵢ is a logic zero (0), the differential data signal D₊ is at 0V and the differential data signal D₋ is at 1V. In such case, a current is formed that flows from the output of the second buffer 362− to the output of the first buffer 362+ via the second transmitter termination resistor R_{T1-}, the negative transmission line 370−, the second receiver termination resistor R_{T2-}, the first receiver termination resistor R_{T2+}, the positive transmission line 370+, and the first transmitter termination resistor R_{T1+}. As the differential voltage V₊−V₋ at the inputs of the differential device 382 is negative, the differential device 382 generates the output data signal D_{O} as a logic zero (0). The power consumed in transmitting the data is 1V²/200Ω= 1/200 W. Thus, the total power consumed for the 1-0 bit interval is 1/200 W+ 1/200 W= 1/100 W.

In single-ended signaling mode, the data communication apparatus 350 operates similar to the standalone single-ended data communication apparatus 250. When the input data signal Dᵢ is a logic one (1), the single-ended data signal D is at 1V. In such case, a single-ended current I (as shown) is formed that flows from the output of the buffer 362+ to ground via the first transmitter termination resistor R_{T1+}, the positive transmission line 370+, and the first receiver termination resistor R_{T2+}. As the differential voltage V₊-Vref at the inputs of the differential device 382 is positive, the differential device 382 generates an output data signal D_{O} as a logic one (1). The power consumed in transmitting the data is 1V²/100Ω= 1/100 W). Similarly, when the input data signal Dᵢ is a logic zero (0), the single-ended data signal D is at 0V. As the differential voltage V₊-Vref at the inputs of the differential device 382 is negative, the differential device 382 generates the output data signal D_{O} as a logic zero (0). In such case, no current is produced; and therefore, the power consumed is 0 W. Thus, the total power consumed for the 1-0 bit interval is 1/100 W+0 W= 1/100 W. Compared to the differential signaling mode, there is essentially no power saving over the 1-0 bit interval by configuring the data communication apparatus 350 in single-ended signaling mode.

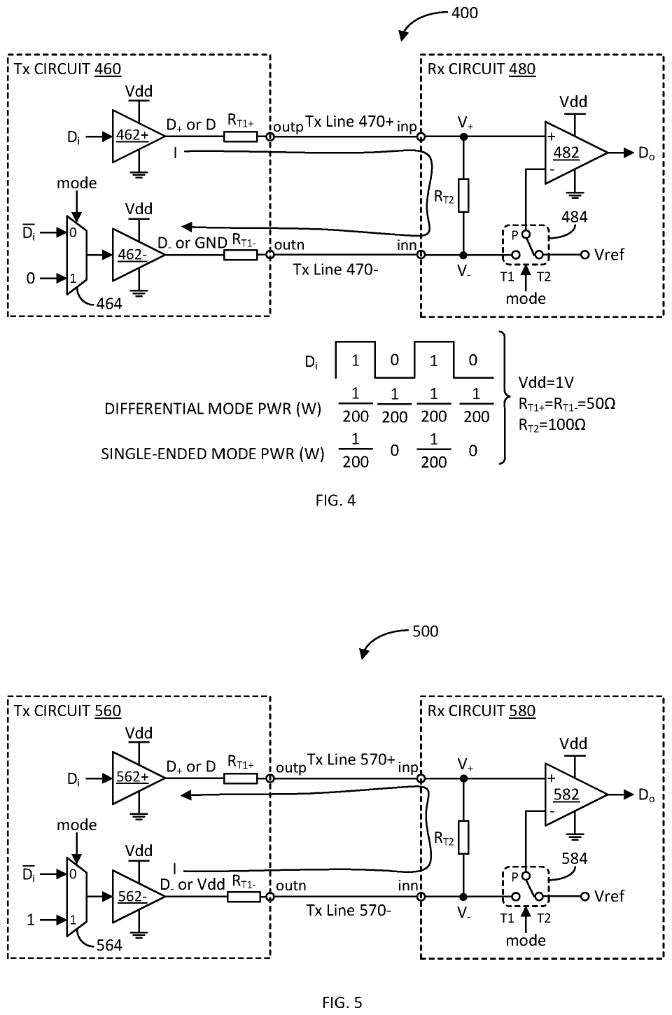

FIG. 4 illustrates a block/schematic diagram of another example data communication apparatus 400 associated with a selectable single-ended or differential signal data lane in accordance with another aspect of the disclosure. The data communication apparatus 400 may be an example of any of the data lanes (transmitter-transmission line-receiver) in data communication apparatus 300. In particular, the data communication apparatus 400 includes a data transmitter circuit 460, a data receiver circuit 480, and a set of transmission lines 470+ and 470−, which may be disposed on a printed circuit board (PCB).

The transmitter circuit 460 includes a first buffer 462+ and a second buffer 462− (e.g., each of which may be referred to as a driver, level-shifter, and/or one or more cascaded inverters). Each of the first and second buffers 462+ and 462− may be coupled between and receive power from an upper voltage rail Vdd and a lower voltage rail (e.g., ground). The first buffer 462+ is configured to generate a differential signal D+ or a single-ended signal D based on an input data signal Dᵢ. The transmitter circuit 460 further includes a first termination resistor R_{T1+} coupled between the output of the first buffer 462+ and a positive output port outp (e.g., IC pin), which is coupled to a first end of the transmission line 470+. To reduce reflections in the transmission of data signals, the resistance of the first termination resistor R_{T1+} may be set to substantially the characteristic impedance of the transmission line 470+ (e.g., 50Ω).

The transmitter circuit 460 may further include a pre-driver multiplexer 464 including a first input “0” configured to receive the input (e.g., complementary) data signal D̅₁̅, a second input “1” configured to receive a fixed voltage potential (e.g., such as ground or a logic zero (0)), and a select input configured to receive a single-ended/differential mode signal. The pre-driver multiplexer 464 includes an output coupled to an input of the second buffer 462−. Accordingly, if the mode signal indicates differential signaling, the second buffer 462− is configured to generate a differential signal D− based on the complementary input data signal D̅₁̅ outputted by the pre-driver multiplexer 464; and if the mode signal indicates single-ended signaling, the second buffer 462− is configured to output the fixed voltage potential (e.g., ground) to configure the transmission line 470− as a current return. The transmitter circuit 460 further includes a second termination resistor R_{T1-} coupled between the output of the second buffer 462− and a negative output port outn (e.g., IC pin), which is coupled to a first end of the transmission line 470−. To reduce reflections in the transmission of data signals, the resistance of the second termination resistor R_{T1-} may be set to substantially the characteristic impedance of the transmission line 470− (e.g., 50Ω).

The data receiver circuit 480 includes a differential device 482 (e.g., comparator or differential amplifier), a termination resistor R_{T2}, and at least one switching device 484. The differential device 482 is coupled between and receives power from the upper voltage rail Vdd and the lower voltage rail (e.g., ground). The differential device 482 includes a first (e.g., positive) input coupled to a positive input port inp (e.g., IC pin), which is coupled to a second end of the transmission line 470+, a second (e.g., negative) input coupled to a terminal (P) (e.g., pole) of the at least one switching device 484, which may be implemented or functions as a SPDT switch. The at least one switching device 484 includes another terminal or throw (T1) coupled to a negative input port inn (e.g., IC pin), which is coupled to a second end of the transmission line 470−. Further, the at least one switching device 484 includes yet another terminal or throw (T2) configured to receive a reference voltage Vref (e.g., set to the common mode voltage of the single-ended voltage swing at the inputs of the differential device 482, such as Vdd*⅜ or 0.375V if Vdd=1V). The at least one switching device 484 includes an input configured to receive the single-ended/differential mode signal, which controls the state of the at least one switching device 484 (e.g., when the mode signal indicates differential, the pole (P) is coupled to the first throw (T1); and when the mode signal indicates single-ended, the pole (P) is coupled to the second throw (T2)). The termination resistor RT2 is coupled between the respective second ends of the transmission lines 470+ and 470−.

FIG. 4 also includes a graph including a signal waveform of the input data signal Dᵢ and a corresponding power consumption (e.g., in watts (W)) associated with differential and single-ended transmission of the input data signal Dᵢ. In differential signaling mode where the multiplexer 464 outputs the complementary input data signal D, and the second end of the transmission line 470− is coupled to the second (e.g., negative) input of the differential device 482 via the at least one switching device 484, the data communication apparatus 400 operates similar to the standalone differential data communication apparatus 150 previously discussed.

For instance, considering again Vdd=1V, R_{T1+}=R_{T1-}=50Ω, and R_{T2}=100Ω, when the input data signal Dᵢ is a logic one (1), the differential data signal D₊ is at 1V and the differential data signal D₋ is at 0V. In such case, a current is formed that flows from the output of the first buffer 462+ (first port of the transmitter circuit 460) to the output of the second buffer 462− (second port of the transmitter circuit 460) via the first transmitter termination resistor R_{T1+}, the positive transmission line 470+, the receiver termination resistor R_{T2}, the negative transmission line 470−, and the second transmitter termination resistor R_{T1-}. The voltage difference V₊-V₋ across the positive and negative inputs of the differential device 482 is positive (e.g., 0.75V−0.25V=0.5V); and thus, the differential device 482 generates the output digital signal Dₒ as a logic one (1). The power consumed in transmitting the data is 1V²/200Ω= 1/200 W.

Similarly, when the input data signal Dᵢ is a logic zero (0), the differential data signal D₊ is at 0V and the differential data signal D₋ is at 1V. In such case, a current is formed that flows from the output of the second buffer 462− to the output of the first buffer 462+ via the second transmitter termination resistor R_{T1-}, the negative transmission line 470−, the receiver termination resistor R_{T2}, the positive transmission line 470+, and the first transmitter termination resistor R_{T1+}. In such case, the voltage difference V₊-V₋ across the positive and negative inputs of the differential device 482 is negative (e.g., 0.25V−0.75V=−0.5V); and thus, the differential device 482 generates the output digital signal Dₒ as a logic zero (0). The power consumed in transmitting the data is 1V²/200Ω= 1/200 W. Thus, the total power consumed for a 1-0 bit interval is 1/200 W+ 1/200 W= 1/100 W.

In single-ended signaling mode, the multiplexer 464 outputs the logic zero (0) so that the second buffer 462− outputs ground potential, and the second (e.g., negative) input of the differential device 482 receives the reference voltage Vref via the at least one switching device 484. The data communication apparatus 400 as follows: When the input data signal Dᵢ is a logic one (1), the single-ended data signal D is at 1V. In such case, a single-ended current I (as shown) is formed that flows from the output of the buffer 462+ to the output of the second buffer 462− via the termination resistors R_{T1+} R_{T2}, and R_{T1-}. The power consumed in transmitting the data is 1V²/200Ω= 1/200 W. Similarly, when the input data signal Dᵢ is a logic zero (0), the single-ended data signal D is at 0V. In such case, no current is produced as ground potential is present at the respective outputs of the buffers 462+ and 464−. Thus, the power consumed in transmitting the data is 0 W. Thus, the total power consumed for a 1-0 bit interval is 1/200 W+0 W= 1/200 W. In this case, compared to the differential signaling mode, the single-ended data transmission saves half the power.

FIG. 5 illustrates a block/schematic diagram of another example data communication apparatus 500 associated with a selectable single-ended or differential signal data lane in accordance with another aspect of the disclosure. The data communication apparatus 500 is a variation of data communication apparatus 400. With regard to single-ended operation of data communication apparatus 400, the first buffer 462+ is responsive to the input data signal Dᵢ, and the second buffer 462− outputs ground potential to configure the transmission line 470− as a single-ended current return. In contrast, with regard to single-ended operation of the data communication apparatus 500, the first buffer 562+ is responsive to the input data signal Dᵢ, and the second buffer 562− outputs Vdd potential to configure the transmission line 570− as a single-ended current supply line.

Similarly, the data communication apparatus 500 may be an example of any of the data lanes (transmitter-transmission line-receiver) in data communication apparatus 300. In particular, the data communication apparatus 500 includes a data transmitter circuit 560, a data receiver circuit 580, and a set of transmission lines 570+ and 570−, which may be disposed on a printed circuit board (PCB).

The transmitter circuit 560 includes a first buffer 562+ and a second buffer 562− (e.g., each of which may be referred to as a driver, level-shifter, and/or one or more cascaded inverters). Each of the first and second buffers 562+ and 562− may be coupled between and receive power from an upper voltage rail Vdd and a lower voltage rail (e.g., ground). The first buffer 562+ is configured to generate a differential signal D₊ or a single-ended signal D based on an input data signal Dᵢ. The transmitter circuit 560 further includes a first termination resistor R_{T1+} coupled between the output of the first buffer 562+ and a positive output port outp (e.g., IC pin), which is coupled to a first end of the transmission line 570+. To reduce reflections in the transmission of data signals, the resistance of the first termination resistor R_{T1+} may be set to substantially the characteristic impedance of the transmission line 570+ (e.g., 50Ω).

The transmitter circuit 560 may further include a pre-driver multiplexer 564 including a first input “0” configured to receive an input (e.g., complementary) data signal D̅₁̅, a second input “1” configured to receive a fixed voltage potential (e.g., such as Vdd or a logic one (1)), and a select input configured to receive a single-ended/differential mode signal. The pre-driver multiplexer 564 includes an output coupled to an input of the second buffer 562−. Accordingly, if the mode signal indicates differential signaling, the second buffer 562− is configured to generate a differential signal D₋ based on the complementary input data signal D̅₁̅ outputted by the pre-driver multiplexer 564; and if the mode signal indicates single-ended signaling, the second buffer 562− is configured to output Vdd. The transmitter circuit 560 further includes a second termination resistor RT1-coupled between the output of the second buffer 562− and a negative output port outn (e.g., IC pin), which is coupled to a first end of the transmission line 570−. To reduce reflections in the transmission of data signals, the resistance of the second termination resistor R_{T1-} may be set to substantially the characteristic impedance of the transmission line 570− (e.g., 50Ω).

The data receiver circuit 580 includes a differential device 582 (e.g., comparator or differential amplifier), a termination resistor R_{T2}, and at least one switching device 584. The differential device 582 is coupled between and receives power from the upper voltage rail Vdd and the lower voltage rail (e.g., ground). The differential device 582 includes a first (e.g., positive) input coupled to a positive input port inp (e.g., IC pin), which is coupled to a second end of the transmission line 570+, a second (e.g., negative) input coupled to a terminal (P) (e.g., pole) of the at least one switching device 584, which may be implemented or functions as a SPDT switch. The at least one switching device 584 includes another terminal or throw (T1) coupled to a negative input port inn (e.g., IC pin), which is coupled to a second end of the transmission line 570−. Further, the at least one switching device 584 includes yet another terminal or throw (T2) configured to receive a reference voltage Vref (e.g., set to the common mode voltage of the single-ended voltage swing at the inputs of the differential device 582, such as Vdd*⅝ or 0.625V if Vdd=1V).

The at least one switching device 584 includes an input configured to receive the single-ended/differential mode signal, which controls the state of the switching device 584 (e.g., when the mode signal indicates differential, the pole (P) is coupled to the first throw (T1); and when the mode signal indicates single-ended, the pole (P) is coupled to the second throw (T2)). The termination resistor R_{T2} is coupled between the respective second ends of the transmission lines 570+ and 570−.

In operation, in differential signaling mode, the multiplexer 564 outputs the complementary input digital signal D̅₁̅, and the at least one switching device 584 is coupling the second end of the transmission line 570− to the second (e.g., negative) input of the differential device 582. When the input data signal Dᵢ is a logic one (1), the differential data signal D₊ may be at 1V and the differential data signal D₋ may be at 0V. In such case, a current is formed that flows from the output (port) of the first buffer 562+ to the output (port) of the second buffer 562− via the first transmitter termination resistor R_{T1+}, the positive transmission line 570+, the receiver termination resistor R_{T2}, the negative transmission line 570−, and the second transmitter termination resistor R_{T1-}. The voltage difference V₊-V₋ across the positive and negative inputs of the differential device 582 is positive (e.g., 0.75V−0.25V=0.5V); and thus, the differential device 582 generates the output digital signal Dₒ as a logic one (1).

When the input data signal Dᵢ is a logic zero (0), the differential data signal D₊ may be at 0V and the differential data signal D₋ may be at 1V. In such case, a current is formed that flows from the output of the second buffer 562− to the output of the first buffer 562+ via the second transmitter termination resistor R_{T1-}, the negative transmission line 570−, the receiver termination resistor R_{T2}, the positive transmission line 570+, and the first transmitter termination resistor R_{T1+}. The voltage difference V₊-V₋ across the positive and negative inputs of the differential device 582 is negative (e.g., 0.25V−0.75V=-0.5V); and thus, the differential device 582 generates the output digital signal Dₒ as a logic zero (0).

In single-ended signaling mode, the multiplexer 564 outputs the logic one (1) so that the second buffer 562− outputs Vdd, and the second (e.g., negative) input of the differential device 582 receives the reference voltage Vref via the at least one switching device 584. In operation, when the input data signal Dᵢ is a logic one (1), the single-ended data signal D is at 1V. In such case, no current flows between both buffers 562+ and 562− as both are outputting Vdd. In such case, the voltage difference V₊-Vref across the positive and negative inputs of the differential device 582 is positive (e.g., Vdd-Vdd*⅝=Vdd*⅜ or 1V−0.625=0.375V); and thus, the differential device 582 generates the output digital signal Dₒ as a logic one (1). When the input data signal Dᵢ is a logic zero (0), the single-ended data signal D is at 0V. In such case, a single-ended current I (as shown) flows from the second buffer 562− to the first buffer 562+ via the termination resistors R_{T1}-R_{T2}, and R_{T1+}. In such case, the voltage difference V₊-Vref across the positive and negative inputs of the differential device 582 is negative (e.g., Vdd* 2/8=Vdd*⅝=−Vdd*⅜ or 0.25V−0.625=−0.375V); and thus, the differential device 582 generates the output digital signal Dₒ as a logic zero (0).

In the description above, the use of the term “substantially” takes into account manufacturing tolerances. For example, if a resistor is described as having a resistance of 50Ω, and the manufacturing tolerance is one percent (1%), then a resistor having a resistance of 50Ω+/−0.152 is said to be a resistor having a resistance of substantially 50Ω. Additionally, in the description above, the signals transmitted between a data transmitter circuit and a data receiver circuit has been described as data signals, it shall be understood that a clock signal (e.g., a substantially periodic signal, such as a square wave) or other type of signal may also be transmitted as described above.

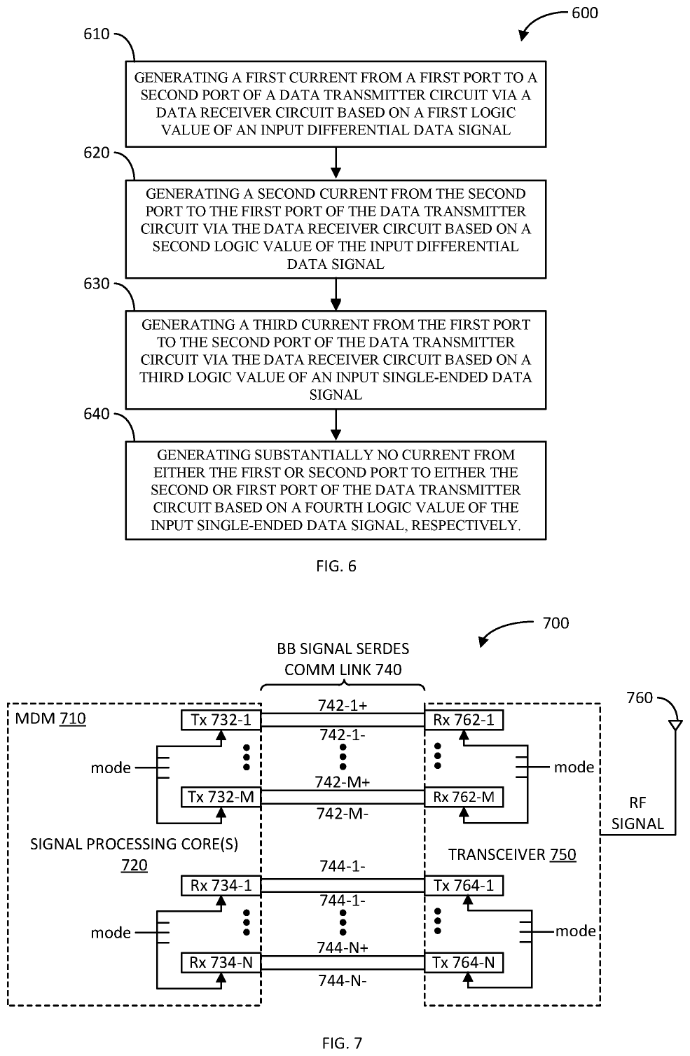

FIG. 6 illustrates a flow diagram of an example method 600 of communicating data from a data transmitter circuit to a data receiver circuit in accordance with another aspect of the disclosure.

The method 600 includes generating a first current from a first port to a second port of a data transmitter circuit via a data receiver circuit based on a first logic value of an input differential data signal (block 610). Examples of means for generating a first current from a first port to a second port of a data transmitter circuit via a data receiver circuit based on a first logic value of an input differential data signal include buffers 462+/462− and 562+/562−, transmission lines 470+/470− and 570+/570− and termination resistors R_{T1+}, R_{T1-}, and R_{T2}. The method 600 further includes generating a second current from the second port to the first port of the data transmitter circuit via the data receiver circuit based on a second logic value of the input differential data signal (block 620). Examples of means for generating a second current from the second port to the first port of the data transmitter circuit via the data receiver circuit based on a second logic value of the input differential data signal include buffers 462+/462− and 562+/562−, transmission lines 470+/470− and 570+/570− and termination resistors R_{T1+}, R_{T1-}, and R_{T2}.

Further, the method 600 includes generating a third current from the first port to the second port of the data transmitter circuit via the data receiver circuit based on a third logic value of an input single-ended data signal (block 630). Examples of means for generating a third current from the first port to the second port of the data transmitter circuit via the data receiver circuit based on a third logic value of an input single-ended data signal include buffers 462+/462− and 562+/562−, transmission lines 470+/470− and 570+/570− and termination resistors R_{T1+}, R_{T1-}, and R_{T2}. Additionally, the method 600 includes generating substantially no current from either the first or second port to either the second or first port of the data transmitter circuit based on a fourth logic value of the input single-ended data signal, respectively (block 640). Examples of means for generating substantially no current from either the first or second port to either the second or first port of the data transmitter circuit based on a fourth logic value of the input single-ended data signal, respectively include buffers 462+/462− and 562+/562−, transmission lines 470+/470− and 570+/570−

The method 600 may further include generating, at the data receiver circuit, a voltage difference based on the first or second current. Examples of means for generating, at the data receiver circuit, a voltage difference based on the first or second current include termination resistors R_{T2}. Further, the method 600 may include generating an output differential data signal based on the voltage difference. Examples of means for generating an output differential data signal based on the voltage difference include the differential devices 482 and 582.

Additionally, the method 600 may include generating, at the data receiver circuit, a voltage difference based on the third current and a reference voltage. Examples of means for generating, at the data receiver circuit, a voltage difference based on the third current and a reference voltage include termination resistors R_{T2}, switching devices 484 and 584, and source of reference voltage Vref. Also, the method 600 includes generating an output single-ended data signal based on the voltage difference. Examples of means for generating an output single-ended data signal based on the voltage difference include the differential devices 482 and 582.

Further, the method 600 includes generating, at the data receiver circuit, a voltage difference based on the substantially no current and a reference voltage. Examples of means for generating, at the data receiver circuit, a voltage difference based on the substantially no current and a reference voltage includes transmission lines 470+ and 570+, switching devices 484 and 584, and sources of the reference voltage V_{ref}. In addition, the method 600 includes generating an output single-ended data signal based on the voltage difference. Examples of means for generating an output single-ended data signal based on the voltage difference include the differential devices 482 and 582.

FIG. 7 illustrates a block diagram of an example electronic device 700 in accordance with another aspect of the disclosure. The electronic device 700 may be a smart phone, a desktop computer, laptop computer, tablet device, Internet of Things (IoT), wearable wireless device (e.g., wireless watch), and other types of wireless device.

In particular, the electronic device 700 includes a modem 710. The modem 710 includes one or more signal processing cores 720 configured to generate a transmit baseband (BB) data signal and process a received BB data signal. The modem 710 additionally includes a first set of one or more data transmitter circuits 732-1 to 732-M configured to transmit the transmit BB data signal based on a differential/single-ended mode signal. Each of the first set of one or more data transmitter circuits 732-1 to 732-M may be implemented per data transmitter circuit 460 or 560. The modem 710 additionally includes a first set of one or more data receiver circuits 734-1 to 734-N configured to receive the received BB data signal based on the differential/single-ended mode signal. Each of the first set of one or more data receiver circuits 734-1 to 734-N may be implemented per data receiver circuit 480 or 580.

The electronic device 700 includes a transceiver 750. The transceiver 750 is configured to convert the transmit BB signal into a transmit radio frequency (RF) signal, and convert a received RF signal into the received BB signal. The transceiver 750 is coupled to the at least one antenna 760 to provide thereto the transmit RF signal for electromagnetic radiation into a wireless medium for wireless transmission, and receive the received RF signal electromagnetically picked up from the wireless medium by the at least one antenna 760.

The transceiver 750 additionally includes a second set of one or more data receiver circuits 762-1 to 762-M configured to receive the transmit BB data signal based on a differential/single-ended mode signal. Each of the second set of one or more data receiver circuits 762-1 to 762-M may be implemented per data receiver circuit 480 or 580. The transceiver 750 additionally includes a second set of one or more data transmitter circuits 764-1 to 764-N configured to transmit the received BB data signal based on the differential/single-ended mode signal. Each of the second set of one or more data transmitter circuits 764-1 to 764-N may be implemented per data transmitter circuit 460 or 560.

Additionally, the electronic device 700 further includes a BB signal SERDES communication link 740. The BB signal SERDES communication link 740 comprises a first set of one or more differential transmission lines 742-1+/742-1− to 742-M+/742-M− coupling the first set of one or more data transmitter circuits 732-1 to 732-M to the second set of one or more receiver circuits 762-1 to 762-M for transmission of the transmit BB signal, respectively. The BB signal SERDES communication link 740 comprises a second set of one or more differential transmission lines 744-1+/744-1− to 742-N+/742-N− coupling the second set of one or more data transmitter circuits 764-1 to 764-N to the first set of one or more receiver circuits 734-1 to 734-N for transmission of the received BB signal, respectively.

The following provides an overview of aspects of the present disclosure:

Aspect 1: An apparatus, comprising: a data receiver circuit, comprising: a differential device configured to output a digital signal based on a differential data signal received via first and second transmission lines, or a single-ended data signal received via the first transmission line, wherein the differential device includes a first input configured to couple to the first transmission line; and at least one switching device including a first terminal coupled to a second input of the differential device, a second terminal configured to couple to the second transmission line, and a third terminal configured to receive a reference voltage.

Aspect 2: The apparatus of aspect 1, wherein the at least one switching device is configured to couple the first and second terminals together based on a mode signal indicating a differential signaling mode.

Aspect 3: The apparatus of aspect 1 or 2, wherein the at least one switching device is configured to couple the first and third terminals together based on a mode signal indicating a single-ended signaling mode.

Aspect 4: The apparatus of aspect 3, further comprising a control circuit configured to generate the mode signal indicating the single-ended signaling mode or a differential signaling mode based on a configuration signal.

Aspect 5: The apparatus of any one of aspects 1-4, further comprising a termination resistor coupled between the first input of the differential device and the second terminal of the at least one switching device.

Aspect 6: The apparatus of any one of aspects 1-5, wherein the differential device is coupled between an upper voltage rail and a lower voltage rail, and wherein the reference voltage is based on a supply voltage at the upper voltage rail.

Aspect 7: The apparatus of any one of aspects 1-6, wherein the reference voltage is based on a common mode voltage of a voltage swing between the first and second inputs of the differential device based on the single-ended signal.

Aspect 8: An apparatus, comprising: a data transmitter circuit, comprising: a first buffer configured to generate a first differential data signal or a single-ended data signal based on an input data signal; and a second buffer configured to generate a second differential data signal based on the input data signal or a fixed voltage potential.

Aspect 9: The apparatus of aspect 8, wherein: the first buffer is configured to generate the first differential data signal based on a mode signal indicating a differential signaling mode; and the second buffer is configured to generate the second differential data signal based on the mode signal indicating the differential signaling mode.

Aspect 10: The apparatus of aspect 9, wherein the first and second differential data signals are complementary signals.

Aspect 11: The apparatus of any one of aspects 8-10, wherein: the first buffer is configured to generate the single-ended data signal based on a mode signal indicating a single-ended signaling mode; and the second buffer is configured to generate the fixed voltage potential based on the mode signal indicating the single-ended signaling mode.

Aspect 12: The apparatus of any one of aspects 8-11, wherein the first and second buffers are each coupled between upper and lower voltage rails, and wherein the fixed voltage potential is substantially the same as a voltage potential at the lower voltage rail.

Aspect 13: The apparatus of any one of aspects 8-12, wherein the first and second buffers are each coupled between upper and lower voltage rails, and wherein the fixed voltage potential is substantially the same as a voltage potential at the upper voltage rail.

Aspect 14: The apparatus of any one of aspects 8-15, wherein the data transmitter circuit further comprises: a first termination resistor coupled to an output of the first buffer; and a second termination resistor coupled to an output of the second buffer.

Aspect 15: The apparatus of aspect 14, wherein the first and second buffers are configured to generate a current that flows from the output of the first buffer to the output of the second buffer or from the output of the second buffer to the output of the first buffer via the first and second termination resistors based on complementary logic values of the first and second differential data signals.

Aspect 16: The apparatus of any one of aspects 14-15, wherein the first and second buffers are configured to: generate a current that flows from the output of the first buffer to the output of the second buffer via the first and second termination resistors based on the single-ended data signal being at a high logic voltage level and the fixed voltage potential being at a low logic voltage level; and substantially no current based on the single-ended signal being at the low logic voltage level and the fixed voltage potential being at the low logic voltage level.

Aspect 17: The apparatus of any one of aspects 14-16, wherein the first termination resistor has a first resistance, the second termination resistor has a second resistance, and the first and second resistances are substantially the same.

Aspect 18: The apparatus of any one of aspects 8-17, further comprising a control circuit configured to generate a mode signal indicating differential or single-ended signaling based on a configuration signal, wherein the first and second buffers are configured to generate the first and second differential data signals or the single-ended data signal and the fixed voltage potential based on the mode signal.

Aspect 19: The apparatus of aspect 18, wherein the control circuit is configured to set the mode signal to differential signaling based on the configuration signal indicating a data rate greater than a threshold.

Aspect 20: The apparatus of aspect 18 or 19, wherein the control circuit is configured to set the mode signal to single-ended signaling based on the configuration signal indicating a data rate less than a threshold.

Aspect 21: A method, comprising: generating a first current from a first port to a second port of a data transmitter circuit via a data receiver circuit based on a first logic value of an input differential data signal; generating a second current from the second port to the first port of the data transmitter circuit via the data receiver circuit based on a second logic value of the input differential data signal; generating a third current from the first port to the second port of the data transmitter circuit via the data receiver circuit based on a third logic value of an input single-ended data signal; and generating substantially no current from either the first or second port to either the second or first port of the data transmitter circuit based on a fourth logic value of the input single-ended data signal, respectively.

Aspect 22: The method of aspect 21, further comprising: generating, at the data receiver circuit, a voltage difference based on the first or second current; and generating an output differential data signal based on the voltage difference.

Aspect 23: The method of aspect 21 or 22, further comprising: generating, at the data receiver circuit, a voltage difference based on the third current and a reference voltage; and generating an output single-ended data signal based on the voltage difference.

Aspect 24: The method of any one of aspects 21-23, further comprising: generating, at the data receiver circuit, a voltage difference based on the substantially no current and a reference voltage; and generating an output single-ended data signal based on the voltage difference.

Aspect 25: An apparatus, comprising: means for generating a first current from a first port to a second port of a data transmitter circuit via a data receiver circuit based on a first logic value of an input differential data signal; means for generating a second current from the second port to the first port of the data transmitter circuit via the data receiver circuit based on a second logic value of the input differential data signal; means for generating a third current from the first port to the second port of the data transmitter circuit via the data receiver circuit based on a third logic value of an input single-ended data signal; and means for generating substantially no current from either the first or second port to either the second or first port of the data transmitter circuit based on a fourth logic value of the input single-ended data signal, respectively.

Aspect 26: The apparatus of aspect 25, further comprising: means for generating, at the data receiver circuit, a voltage difference based on the first or second current; and means for generating an output differential data signal based on the voltage difference.

Aspect 27: The apparatus of aspect 25 or 26, further comprising: means for generating, at the data receiver circuit, a voltage difference based on the third current and a reference voltage; and means for generating an output single-ended data signal based on the voltage difference.

Aspect 28: The apparatus of any one of aspects 25-27, further comprising: means for generating, at the data receiver circuit, a voltage difference based on the substantially no current and a reference voltage; and means for generating an output single-ended data signal based on the voltage difference.

Aspect 29: An electronic device, comprising: a first transmission line; a second transmission line; a modem or transceiver including a data transmitter circuit, comprising: a first buffer configured to generate a first differential data signal or a single-ended data signal based on an input data signal and a mode signal indicating differential or single-ended signaling, respectively, wherein an output of the first buffer is coupled to the first transmission line; and a second buffer configured to generate a second differential data signal based on the input data signal or a fixed voltage potential based on the mode signal, respectively, wherein an output of the second buffer is coupled to the second transmission line; and the transceiver or the modem including a data receiver circuit, comprising: at least one switching device including first, second, and third terminals, wherein the second terminal is coupled to the second transmission line, and the third terminal is configured to receive a reference voltage, and wherein the at least one switching device is responsive to the mode signal; and a differential device including a first input coupled to the first transmission line, a second input coupled to the first terminal of the at least one switching device, and an output configured to generate an output digital signal based on the first and second differential data signals or the single-ended data signal.

Aspect 30: The electronic device of aspect 29, further comprising a control circuit configured to generate the mode signal based on data rate information.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. An apparatus, comprising:
a data receiver circuit, comprising:
a differential device configured to output a digital signal based on a differential data signal received via first and second transmission lines, or a single-ended data signal received via the first transmission line, wherein the differential device includes a first input configured to couple to the first transmission line; and
at least one switching device including a first terminal coupled to a second input of the differential device, a second terminal configured to couple to the second transmission line, and a third terminal configured to receive a reference voltage.

2. The apparatus of claim 1, wherein the at least one switching device is configured to couple the first and second terminals together based on a mode signal indicating a differential signaling mode.

3. The apparatus of claim 1, wherein the at least one switching device is configured to couple the first and third terminals together based on a mode signal indicating a single-ended signaling mode.

4. The apparatus of claim 3, further comprising a control circuit configured to generate the mode signal indicating the single-ended signaling mode or a differential signaling mode based on a configuration signal.

5. The apparatus of claim 1, further comprising a termination resistor coupled between the first input of the differential device and the second terminal of the at least one switching device.

6. The apparatus of claim 1, wherein the differential device is coupled between an upper voltage rail and a lower voltage rail, and wherein the reference voltage is based on a supply voltage at the upper voltage rail.

7. The apparatus of claim 1, wherein the reference voltage is based on a common mode voltage of a voltage swing between the first and second inputs of the differential device based on the single-ended signal.

8. An apparatus, comprising:
a data transmitter circuit, comprising:
a first buffer configured to generate a first differential data signal or a single-ended data signal based on an input data signal; and
a second buffer configured to generate a second differential data signal based on the input data signal or a fixed voltage potential.

9. The apparatus of claim 8, wherein:
the first buffer is configured to generate the first differential data signal based on a mode signal indicating a differential signaling mode; and
the second buffer is configured to generate the second differential data signal based on the mode signal indicating the differential signaling mode.

10. The apparatus of claim 9, wherein the first and second differential data signals are complementary signals.

11. The apparatus of claim 8, wherein:
the first buffer is configured to generate the single-ended data signal based on a mode signal indicating a single-ended signaling mode; and
the second buffer is configured to generate the fixed voltage potential based on the mode signal indicating the single-ended signaling mode.

12. The apparatus of claim 8, wherein the first and second buffers are each coupled between upper and lower voltage rails, and wherein the fixed voltage potential is substantially the same as a voltage potential at the lower voltage rail.

13. The apparatus of claim 8, wherein the first and second buffers are each coupled between upper and lower voltage rails, and wherein the fixed voltage potential is substantially the same as a voltage potential at the upper voltage rail.

14. The apparatus of claim 8, wherein the data transmitter circuit further comprises:
a first termination resistor coupled to an output of the first buffer; and
a second termination resistor coupled to an output of the second buffer.

15. The apparatus of claim 14, wherein the first and second buffers are configured to generate a current that flows from the output of the first buffer to the output of the second buffer or from the output of the second buffer to the output of the first buffer based on complementary logic values of the first and second differential data signals.

16. The apparatus of claim 14, wherein the first and second buffers are configured to:
generate a current that flows from the output of the first buffer to the output of the second buffer via the first and second termination resistors based on the single-ended data signal being at a high logic voltage level and the fixed voltage potential being at a low logic voltage level; and
substantially no current based on the single-ended signal being at the low logic voltage level and the fixed voltage potential being at the low logic voltage level.

17. The apparatus of claim 14, wherein the first termination resistor has a first resistance, the second termination resistor has a second resistance, and the first and second resistances are substantially the same.

18. The apparatus of claim 8, further comprising a control circuit configured to generate a mode signal indicating differential or single-ended signaling based on a configuration signal, wherein the first and second buffers are configured to generate the first and second differential data signals or the single-ended data signal and the fixed voltage potential based on the mode signal.

19. The apparatus of claim 18, wherein the control circuit is configured to set the mode signal to differential signaling based on the configuration signal indicating a data rate greater than a threshold.

20. The apparatus of claim 18, wherein the control circuit is configured to set the mode signal to single-ended signaling based on the configuration signal indicating a data rate less than a threshold.

21. A method, comprising:
generating a first current from a first port to a second port of a data transmitter circuit via a data receiver circuit based on a first logic value of an input differential data signal;
generating a second current from the second port to the first port of the data transmitter circuit via the data receiver circuit based on a second logic value of the input differential data signal;
generating a third current from the first port to the second port of the data transmitter circuit via the data receiver circuit based on a third logic value of an input single-ended data signal; and
generating substantially no current from either the first or second port to either the second or first port of the data transmitter circuit based on a fourth logic value of the input single-ended data signal, respectively.

22. The method of claim 21, further comprising:
generating, at the data receiver circuit, a voltage difference based on the first or second current; and
generating an output differential data signal based on the voltage difference.

23. The method of claim 21, further comprising:
generating, at the data receiver circuit, a voltage difference based on the third current and a reference voltage; and
generating an output single-ended data signal based on the voltage difference.

24. The method of claim 21, further comprising:
generating, at the data receiver circuit, a voltage difference based on the substantially no current and a reference voltage; and
generating an output single-ended data signal based on the voltage difference.

25. An apparatus, comprising:
means for generating a first current from a first port to a second port of a data transmitter circuit via a data receiver circuit based on a first logic value of an input differential data signal;
means for generating a second current from the second port to the first port of the data transmitter circuit via the data receiver circuit based on a second logic value of the input differential data signal;
means for generating a third current from the first port to the second port of the data transmitter circuit via the data receiver circuit based on a third logic value of an input single-ended data signal; and
means for generating substantially no current from either the first or second port to either the second or first port of the data transmitter circuit based on a fourth logic value of the input single-ended data signal, respectively.

26. The apparatus of claim 25, further comprising:
means for generating, at the data receiver circuit, a voltage difference based on the first or second current; and
means for generating an output differential data signal based on the voltage difference.

27. The apparatus of claim 25, further comprising:
means for generating, at the data receiver circuit, a voltage difference based on the third current and a reference voltage; and
means for generating an output single-ended data signal based on the voltage difference.

28. The apparatus of claim 25, further comprising:
means for generating, at the data receiver circuit, a voltage difference based on the substantially no current and a reference voltage; and
means for generating an output single-ended data signal based on the voltage difference.
